(19) United States
(12) Patent Application Publication
(10) Pub. No.: US 2006/0175208 A1
(43) Pub. Date: Aug. 10, 2006

(54) Water-conductivity CO2 sensor

(76) Inventors: Steven J. Eickhoff, Plymouth, MN (US); Roland Andrew Wood, Bloomington, MN (US)

Correspondence Address: Kris T. Fredrick;Patent Services, Honeywell International Inc., 101 Columbia Road, Morristown, NJ, 07962, US

(21) Appl. No.: 11/055,174

(22) Filed: Feb. 9, 2005

(51) Int. Cl. G01F 1/64; G01N 27/26

(52) U.S. Cl. 205/783; 204/415; 204/424

(57) ABSTRACT

A sensor for measuring CO₂ in an ambient atmosphere, typically air in a room. The sensor body is inert to water and CO₂, and has a chamber proximate the atmosphere of interest. Pure water is placed in the chamber and separated from the atmosphere by a CO₂ permeable membrane to allow the atmosphere to pass into the water. Conductivity is measured and the concentration of CO₂ as a function of conductivity is displayed. Temperature is measured to further refine the measurement data.

### FIELD OF THE INVENTION

The present invention relates in general to a sensor for detecting the presence of CO₂ in an environment. More particularly, the present invention relates to the use of conductivity measurements of water that has been exposed to an atmosphere where CO₂ may be present, to sense the presence of CO₂ and provide a warning, if necessary.

### BACKGROUND OF THE INVENTION

Low cost CO₂ sensors are desired for indoor air quality sensing. Prior art CO₂ sensing for this environment, using IR absorption for exampOle, are technically successful but are too expensive for air quality sensing.

It is also known that CO₂ dissolves in water and creates ionic species that increase the conductivity of water. U.S. Pat. No. 5,904,833 to Huber et al. Discloses electrical conductivity measurement of CO₂ in water where a membrane permits the CO₂ to flow from boiler water using a relatively complicated scheme of reference chambers, indicator chambers, and the like, such that the CO₂ is transferred through the membrane constantly and is precipitated out to give a continuous monitoring system. This would not be practical for environment sensing. U.S. Pat. No. 6, 541,268 to Tonnessen teaches use of CO₂ permeable membranes that are in contact with water, disclosing sensors that are intended to be used in or on a human body, in blood vessels, organs and the like. Finally, U.S. Pat. No. 6,451,613 to Blades et al. Discloses a system in which the total organic content of a liquid is measured by converting the organic content to CO₂ by combustion, followed by combined static and continuous flow measurements.

It would be of great advantage if a much simpler sensor for CO₂ could be developed that would efficiently and accurately operate in an indoor environment.

Another advantage would be if a simple CO₂ sensor could be developed that would use miniaturized components that would operate at low energy costs while providing high accuracy.

Other advantages and features will appear hereinafter.

### SUMMARY OF THE INVENTION

The present invention provides a sensor for measuring CO₂ in an ambient atmosphere. A sensor body is formed from a material such as PFA Teflon that is inert to water and CO₂. The body has a chamber proximate the atmosphere of interest, typically air in a room.

Ionically pure water is placed in the chamber and separated from the atmosphere by a CO₂ permeable membrane to allow the atmosphere to pass into the water. Air is allowed to pass over the membrane in one embodiment so that the CO₂ enters the water. The CO₂ changes the conductivity of water since it dissolves in pure water to form ionic species. The conductivity is measured (or its reciprocal, resistivity) and the concentration of CO₂ as a function of conductivity is displayed.

In a preferred embodiment, water temperature is also measured to further refine the measurement data since concentrations of CO₂ vary in water at different temperatures. In one embodiment, the water is heated to 100° C. to drive out all CO₂, since CO₂ is insoluble in water at that temperature. An alternative embodiment for purging the water of CO₂ is to bubble an inert gas such as N₂ to flush out the CO₂.

An alternative embodiment employs the use of a small pump, such as a micro pump to force the ambient atmosphere into the water, thus releasing the CO₂ contained in the air.

### BRIEF DESCRIPTION OF THE DRAWINGS

For a more complete understanding of the invention, reference is hereby made to the drawings, in which:

FIG. 1 is a plot of resistivity for an embodiment of the present invention;

FIG. 2 is a side elevational view in cross section of an embodiment of the present invention;

FIG. 3 is a plot of conductivity versus time for an embodiment of the present invention;

FIG. 4 is a plot of resistivity versus time for an embodiment of the present invention;

FIG. 5 is a plot of conductivity versus time for an embodiment of the present invention;

FIG. 6 is a side elevational view in cross section of another embodiment of the present invention;

In the figures, like reference characters designate identical or corresponding components and units throughout the several views.

### DETAILED DESCRIPTION OF THE PREFERRED EMBODIMENT

The present invention is shown in FIGS. 2 and 6, in two embodiments. The device, 10 generally, includes a sensor body 11 which defines a chamber 13 which contains tonically pure water 15. Membrane 17 separates the water 15 from the ambient atmosphere 19. Conductivity is measured by a conductivity meter 21.

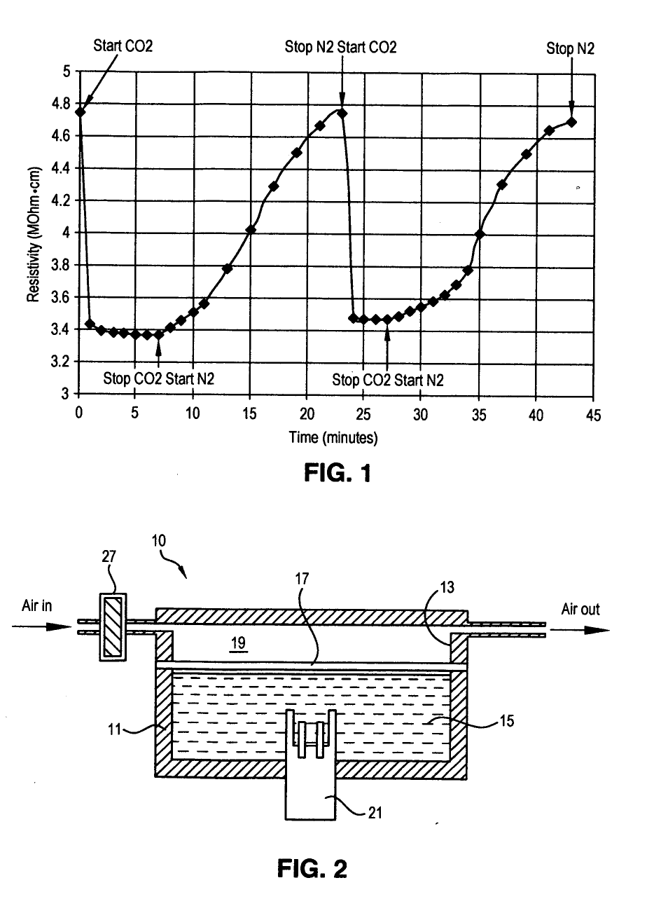

To demonstrate the present invention, the conductivity of deionized water was measured as CO₂ and N₂ were alternately bubbled through it. FIG. 1 is a plot of resistivity (the reciprocal of conductivity) versus time, illustrating how the ionization of CO₂ changes conductivity. The resistivity had an initial value of 4.75 Mohm-cm, which fell almost immediately to 3.4 Mohm-cm when CO₂ was added. The resistivity slowly climbed back to 4.75 Mohm-cm when nitrogen was bubbled through the water to flush out the CO₂. Two cycles are shown in FIG. 1, but additional cycles produced similar results.

The membrane in FIGS. 2 and 6 is CO₂ permeable and is also water vapor impermeable. A thin layer of polytetrafluoroethylene, known as PFA in the trade, and also known by the DuPont trademark Teflon®, is the preferred membrane material but other materials having the same permeability properties are also contemplated. In the preferred embodiment, the body 11 of the sensor may also be made from PFA. The present invention is useful in any environment, and is admirably suited for use in a closed room or in a vehicle where the CO₂ concentration in the air may build up to levels that are potentially unhealthy or unsafe.

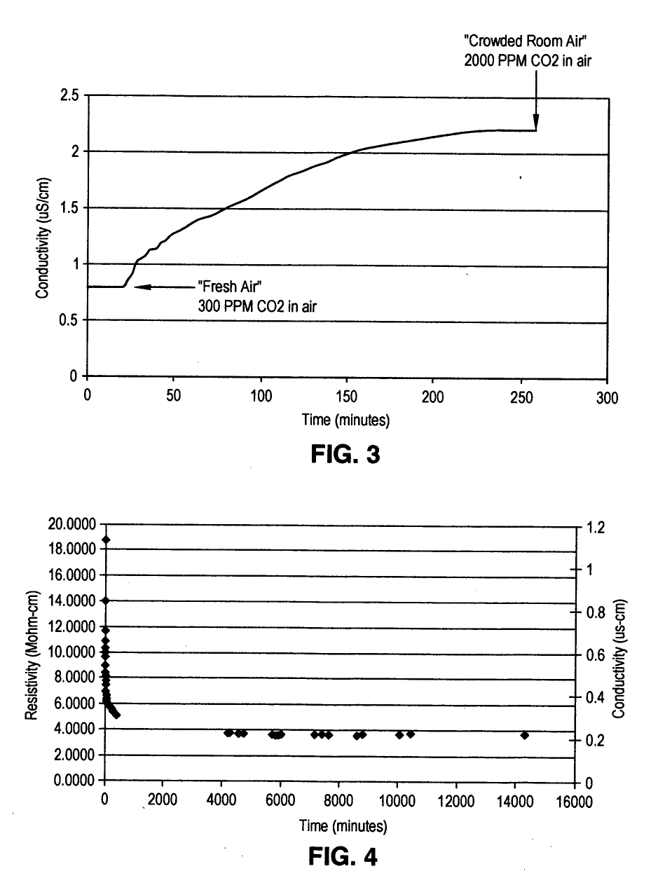

In FIGS. 2 and 6, if a CO₂ concentration difference exists across membrane 17, CO₂ Will permeate membrane 17 and change the conductivity of the water 15. Mixtures of known concentrations of CO₂ were used to test the response of the present invention. A mixture of 300 ppm of CO₂ in air, which is typical of fresh air, was passed through the space above membrane 17 in FIG. 2, until the conductivity stabilized. Then a mixture of CO₂ in air of 2000 ppm, which is typical of air in a crowded room, was then passed through the same space. FIG. 3 illustrates the change in conductivity which gave the results needed. The response time for the change in CO₂ concentration for this simple example was about 220 minutes, which agreed quite well with calculations. While 220 minutes is too long, larger membranes and smaller water volume would reduce the response time to a few minutes.

In FIG. 4, the results of long-term stability of deionized water is shown, as resistivity was monitored as a function of time. As noted, the resistivity leveled off and stayed close to that value for the duration of the test. No drift Was evident during the ten day test.

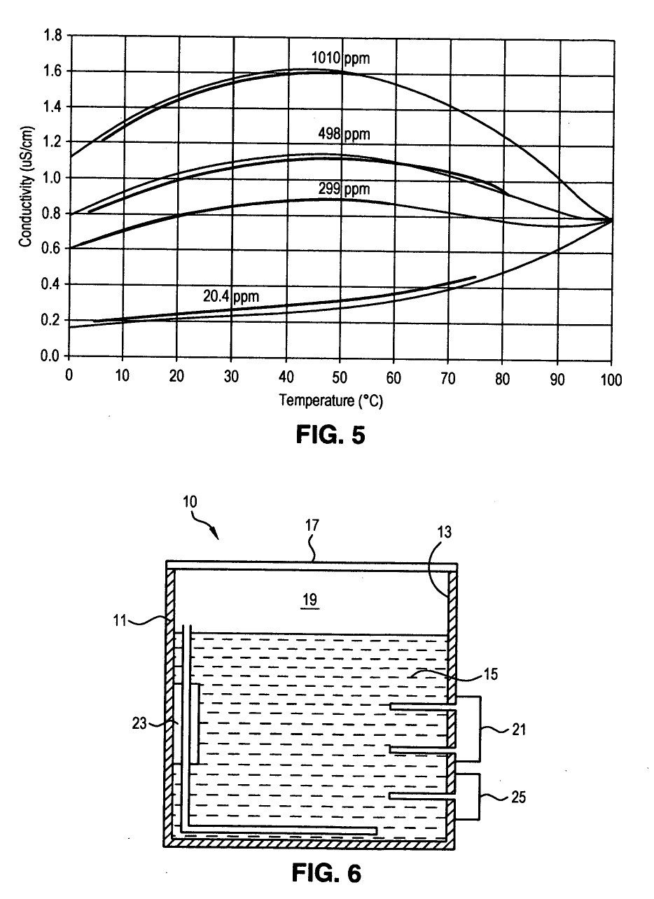

The present invention relies on the fact that the conductivity of water changes both as a function of CO₂ and with temperature. FIG. 5 illustrates the various temperature conductivity values over a temperature range for difference concentrations of CO₂. Of course at 100° C., CO₂ is insoluble, and this can be used to flush or recalibrate the sensor between uses or after a long period of storage or use. FIG. 5 also shows that the difference in conductivity at 200 and 1010 ppm is 100 times the noise level of a typical industrial conductivity sensor.

FIG. 6 shows another embodiment of the present invention, in which a temperature sensor 25 is also used, and the data shown in FIG. 5 is derived using this embodiment. Also used in FIG. 6 is a pump 23, such as a conventional micro pump, to cause air to be circulated in the water 15 to increase the speed of operation of the sensor. Other forms of agitators like pump 23 may include a mechanical stirrer, a gas bubbler and an ultrasonic vibrator. When the system operates over a long period of time, some water may escape through membrane 17 and a source of additional pure water, not shown, may be connected to circulation pump 23 or by a separate water source.

Another embodiment is shown in FIG. 1, comprising a filter 27 positioned between sensor body 11 and ambient atmosphere 19 for filtering non CO₂ gasses from ambient atmosphere 19 as it passes through membrane 17. Examples of said non CO₂ gasses are NO, NO₂, and SO₂.

While particular embodiments of the present invention have been illustrated and described, they are merely exemplary and a person skilled in the art may make variations and modifications to the embodiments described herein without departing from the spirit and scope of the present invention. All such equivalent variations and modifications are intended to be included within the scope of this invention, and it is not intended to limit the invention, except as defined by the following claims.

1. A sensor device for measuring CO₂ in an ambient atmosphere, comprising:
a sensor body inert to water and CO₂, said body having a chamber adapted to be functionally proximate an ambient atmosphere;
a quantity of ionically pure water in said chamber;
a membrane separating said water from said ambient atmosphere, said membrane being CO₂ permeable and water vapor impermeable such that said membrane is in contact with said atmosphere;
a conductivity meter in contact with said water for measuring the conductivity of said water; and
a signal for indicating the CO₂ concentration as a function of said conductivity.

2. The device of claim 1, wherein said ambient atmosphere is air in a room.

3. The device of claim 1, which further includes a temperature sensor for providing temperature data to said display as part of the indicating of the CO₂ concentration.

4. The device of claim 1, which further includes a source of inert gas to purge CO₂ from said water.

5. The device of claim 1, which further includes an agitator for agitating said water to increase the rate at which CO₂ achieves equilibrium in said water.

6. The device of claim 5, wherein said agitator is selected from a mechanical stirrer, a gas bubbler and an ultrasonic vibrator.

7. The device of claim 1, which further includes a source of additional water for replenishing said water in said container to a desirable level.

8. The device of claim 1, which further includes a filter positioned between said sensor body and said ambient atmosphere for filtering non CO₂ gasses from said ambient atmosphere as it passes through said membrane.

9. The device of claim 8, where said non CO₂ gasses are selected from NO, NO₂, and SO₂.

10. The device of claim 10, which further includes a heat source for raising the temperature of said water to 100° C. to purge CO₂ from said water.

11. The device of claim 10, wherein said membrane is a PFA membrane.

12. A sensor device for measuring CO₂ in an ambient atmosphere, comprising:
sensor body means inert to water and CO₂, for providing a chamber adapted to be functionally proximate an ambient atmosphere;
a quantity of ionically pure water in said chamber;
membrane means for separating said water from said ambient atmosphere, said membrane means being CO₂ permeable and water vapor impermeable such that said membrane means is in contact with said atmosphere;
conductivity meter means in contact with said water for measuring the conductivity of said water; and
signal means for indicating the CO₂ concentration as a function of said conductivity.

13. The device of claim 12 , wherein said ambient atmosphere is air in a room.

14. The device of claim 12, which further includes a temperature sensor means for providing temperature data to said display means as part of the indicating of the CO₂ concentration.

15. The device of claim 12, which further includes inert gas source means for purging CO₂ from said water.

16. The device of claim 12, which further includes heat source means for raising the temperature of said water to 100° C. to purge CO₂ from said water.

17. The device of claim 12, wherein said membrane means is formed from a PFA membrane.

18. The device of claim 12, which further includes an agitator for agitating said water to increase the rate at which CO₂ achieves equilibrium in said water.

19. The device of claim 18, wherein said agitator is selected from a mechanical stirrer, a gas bubbler and an ultrasonic vibrator.

20. The device of claim 12, which further includes a source of additional water for replenishing said water in said container to a desirable level.

21. The device of claim 12, which further includes a filter positioned between said sensor body and said ambient atmosphere for filtering non CO₂ gasses from said ambient atmosphere as it passes through said membrane.

22. The device of claim 21, where said non CO₂ gasses are selected from NO, NO₂, and SO₂.

23. A method of measuring CO₂ in an ambient atmosphere, comprising the steps of:
providing a quantity of ionically pure water in a chamber adapted to be functionally proximate an ambient atmosphere;
separating said water from said ambient atmosphere with a membrane CO₂ permeable and water vapor impermeable such that said membrane means is in contact with said atmosphere;
measuring the conductivity of said water; and
indicating the CO₂ concentration as a function of said conductivity.

24. The method of claim 23, wherein said ambient atmosphere is air in a room.

25. The method of claim 23, which further includes the step of measuring the temperature of said water and using that measurement to calculate the CO₂ concentration in said water.

26. The method of claim 23, which further includes the step of heating said water to 100° C. to purge CO₂ from said water prior to contacting said ambient atmosphere.

27. The method of claim 23, which further includes the step of purging the CO₂ concentration in said water by passing an inert gas through said water prior to contacting said ambient atmosphere.

28. The method of claim 23, wherein said membrane is a PFA membrane.

29. The method of claim 23, which further includes the step of agitating said water to increase the rate at which CO₂ achieves equilibrium in said water.

30. The method of claim 23, wherein an agitator is selected from a mechanical stirrer, a gas bubbler and an ultrasonic vibrator.

31. The method of claim 23, which further includes replenishing said water in said container to a desirable level.

32. The method of claim 23, which further includes filtering non CO₂ gasses from said ambient atmosphere as it passes through said membrane.

33. The method of claim 32, where said non CO₂ gasses are selected from NO, NO₂, and SO₂.
